(19) United States
(12) Patent Application Publication
(10) Pub. No.: US 2018/0257209 A1
(43) Pub. Date: Sep. 13, 2018

(54) HAND-HELD DRIVE-IN DEVICE AND METHOD FOR OPERATING SUCH A DRIVE-IN DEVICE

(71) Applicant: Hilti Aktiengesellschaft, Schaan (LI)

(72) Inventors: Mario GRAZIOLI, Chur (CH); Peter BRUGGMUELLER, Bludesch (AT); Karl FRANZ, Feldkirch (AT); Emanuel KURTH, Chur (CH)

(21) Appl. No.: 15/761,842

(22) PCT Filed: Oct. 18, 2016
(86) PCT No.: PCT/EP2016/074949

§ 371 Date: Mar. 21, 2018

(30) Foreign Application Priority Data
Oct. 21, 2015 (EP) 15190756.5

(51) Int. Cl. B25C 1/06; B25C 5/15

(52) U.S. Cl. CPC B25C 1/06; B25C 5/15

(57) ABSTRACT

A hand-held drive-in device for fastening elements has a drive arrangement for a drive-in ram which is mounted so as to be movable in a guide, the ram being coupled via a transmission device to at least one drive spring element which can be tensioned via a tensioning device, wherein the transmission device and the drive spring element have masses. In order to improve the quality of setting operations, the masses of the transmission device and of the drive spring element are tailored to one another such that, when driving a fastening element at a drive-in point into a substrate, the hand-held drive-in device experiences a supporting force which acts in the direction of the substrate and serves, with the hand-held drive-in device, to exert pressure on the surroundings of the drive-in point.

### TECHNICAL FIELD

The invention relates to a hand-held driving tool for fastening elements having a drive arrangement for a driving ram which is displaceably mounted in a guide, said ram being coupled via a transmission device to at least one driving spring element which may be tensioned via a tensioning device, wherein the transmission device and the driving spring element have weights. The invention further relates to a method for operating said hand-held driving tool.

### PRIOR ART

From the German published patent application DE 10 2005 000 089 A1, a hand-held driving tool for fastening elements is known having a drive arrangement for a driving ram which is displaceably mounted in a guide, said ram having at least one driving spring element that may be tensioned via a tensioning device, wherein between the at least one driving spring element and the driving ram, a transmitting device is interposed, wherein the at least one driving spring is supported against one end integrally with the housing and is coupled to the other end to a spring driven element, by which the driving spring element is coupled to the transmitting device. From the European patent specification EP 1 980 369 B1 a hand-held driving tool for fastening elements is known having a drive arrangement for a driving ram displaceably mounted in a guide, said ram having at least one first driving spring element that may be tensioned via a tensioning device and having a first expansion direction, wherein at least one second driving spring element is provided having a second expansion direction, which is set contrary to the first expansion direction.

### DESCRIPTION OF THE INVENTION

The problem of the invention is to improve the quality of the setting operations which can be carried out with a hand-held tool having a drive arrangement for a driving ram displaceably mounted in a guide, said ram being coupled via a transmission device to at least one driving spring element, which may be tensioned via a tensioning device, wherein the driving ram, the transmission device, and the driving spring element are weighted.

The problem during use of a hand-held driving tool for fastening elements having a driving ram displaceably mounted in a guide, which is coupled via a transmission device having at least one driving spring element, which can be tensioned via a tensioning device, wherein the driving ram is to be displaced in a driving direction onto a drive-in point of a substrate when the transmission device and/or the driving spring element move contrary to the drive-in direction, wherein the driving ram, the transmission device and the driving spring element are weighted, is solved in that the weights of the transmission device and/or of the driving spring element are adjusted to the weight of the driving ram such that the hand-held driving tool when driving a fastening element experiences a supporting force at the drive-in point, which acts in the direction of the substrate and serves with the hand-held driving tool to exert pressure on the area surrounding the drive-in point. In this way, the onset of undesired chipping from concrete, for example, around the drive-in point can be markedly reduced. The tensioning device comprises for example a motor by means of which a driving roller can be driven. The motor is designed for example as an electric motor, and has a driven means such as a driven wheel which may be coupled with the driving roller. Via the driven roller of the motor and the driving roller, a force can be applied via through the driving ram for tensioning the driving spring element. The driving spring element and the movable parts of the transmission device are preferably arranged coaxially with regard to the guide for the driving ram. By adjusting the weights and possibly the stiffness of the transmission device and/or of the driving spring element or the driving tool, with the hand-held driving tool, the supporting force can be precisely produced in the area around the drive-in point, while the fastening element drives into the substrate. The hand-held driving tool preferably comprises an electric motor for the tensioning device and advantageously is battery driven.

A preferred embodiment of the hand-held driving tool is thus characterized in that the hand-held driving tool comprises an attachment that during driving in of a fastening element is arranged between the hand-held driving tool and the substrate and through which the supporting force is transmitted from the hand-held driving tool to the area around the drive-in point. The attachment is preferably designed and arranged such that during driving in of the fastening element, it lies against the area around the drive-in point. In this way, the quality of settings can be improved. Especially preferably, the attachment is decoupled from the hand-held driving tool such that during a recoil movement of the hand-held driving tool counter to the driving direction, initially the hand-held driving tool does not move with it. Due to its inertia, the attachment then for a long time counteracts chipping around the drive-in point. Alternatively, the attachment is rigidly joined to the driving tool, preferably to the housing or fastening element guide of the driving tool.

A further preferred embodiment of the hand-held driving tool is characterized in that the sum of double the weight of the driving spring element and weight of the roller retainer of the transmission device is greater than double the weight of the driving ram. In studies and tests performed within the scope of the present invention, movements of the individual device components as well as their respective recoils were dynamically observed. In a static observation, that is shortly before any setting process, the driving spring element pushes the hand-held driving tool forward, thus in the direction of the substrate, while part of the transmission device, in particular a transmission means, produces a tensile force, wherein the driving ram pulls the hand-held driving tool forward. In the adjustment of the weights in accordance with the invention, care is taken in particular that a center of gravity of the driving spring element moves at a different velocity, in particular half as fast, and the piston likewise moves with a different velocity, in particular twice as fast as a part of the transmission device, in particular a roller retainer of the transmission device. In this way the hand-held driving tool experiences a force in the substrate direction whose duration can be set with the stiffness of the housing and/or possibly of the attachment of the hand-held driving tool or with an additional spring device between the housing and the substrate.

A further preferred exemplary embodiment of the hand-help driving tool is characterized in that the weights of the transmission device and of the drive spring element are adjusted to one another in such a way that a peak value of the supporting force is more than 100 N, in particular more than 1000 N. The studies that were done within the scope of the present invention revealed that with supporting forces in the range of a few kilonewtons, very high-value settings can be produced.

A further preferred exemplary embodiment of the hand-held driving tool is characterized in that the transmission device is designed as a roller traction drive transmission, preferably as a cable-pull transmission with a transmission means, especially preferably a cable or belt, which is guided over roller means and is drivingly connected to the driving ram. The weights of the transmission means and the roller means are advantageously considered in the adjustment of the weights of the transmission device and the driving spring element. In this way the quality of these settings can be further improved.

A further preferred exemplary embodiment of the hand-held driving tool is characterized in that the transmission device comprises at least one roller retainer, the weight of which is taken into consideration in adjusting the weights of the transmission device in the driving spring element. By means of the weight of the roller retainer, the supporting force can be set especially advantageously or varied with regard to different device types.

A further preferred exemplary embodiment of the hand-held driving tool is characterized in that the hand-held driving tool comprises a driving spring supported on one side in a housing of the hand-held driving tool. The driving spring is designed for example as a helical compression spring, which is arranged coaxially with respect to the driving ram.

A further preferred exemplary embodiment of the hand-held driving tool is characterized in that the hand-held driving tool comprises two asymmetrically designed driving springs that are supported in a housing of the hand-held driving tool. The driving springs are for example helical compression springs that are arranged coaxially to the driving ram. The two helical compression springs are preferably supported with ends facing one another on a common support point that is integral with the housing. Given the asymmetrical configuration of the driving springs, it is advantageous if a backward expanding spring element, thus a spring element expanding away from the substrate, is heavier than a forward expanding spring element, thus a spring element expanding in the direction of the substrate. The asymmetry is preferably so great that the resultant total force of the driving spring elements is sufficient to push the hand-held driving tool, possibly via the attachment, for a short time against the substrate.

In a method for operating the above described hand-held driving tool, the above indicated problem is alternatively or additionally solved in that when driving a fastening element, weighted parts of the transmission device and the drive arrangement move relative to one another in such a way that the hand-held driving tool when driving the fastening element at the drive-in point exerts a supporting force on the substrate. Here it is knowingly accepted that a recoil in operation of the hand-held driving tool becomes greater, which is undesirable per se.

A preferred exemplary embodiment of the method is characterized in that the effects time of the supporting force when driving the fastening element is less than a tenth of a second, in particular less than a hundredth of a second. The effects time of the supporting force when driving the fastening element is preferably only a few milliseconds.

Further advantages, features, and details of the invention may be found in the following description, in which various exemplary embodiments are described in detail with reference to the drawing. Wherein:

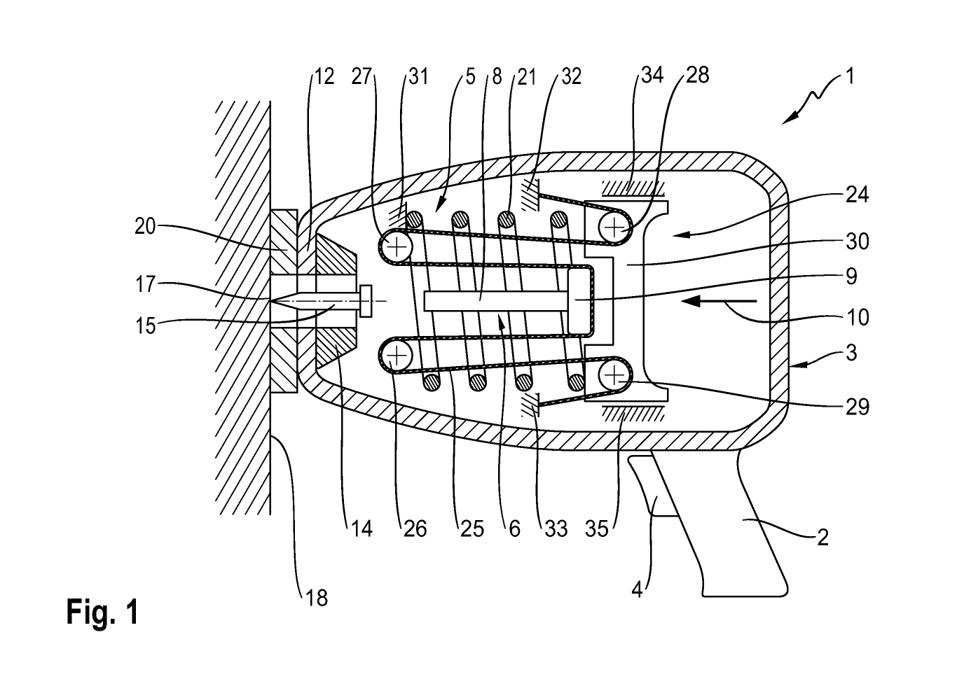

FIG. 1 is a simplified representation of the hand-held driving tool having a driving spring supported on one side in a housing of the hand-held driving tool, in longitudinal section and

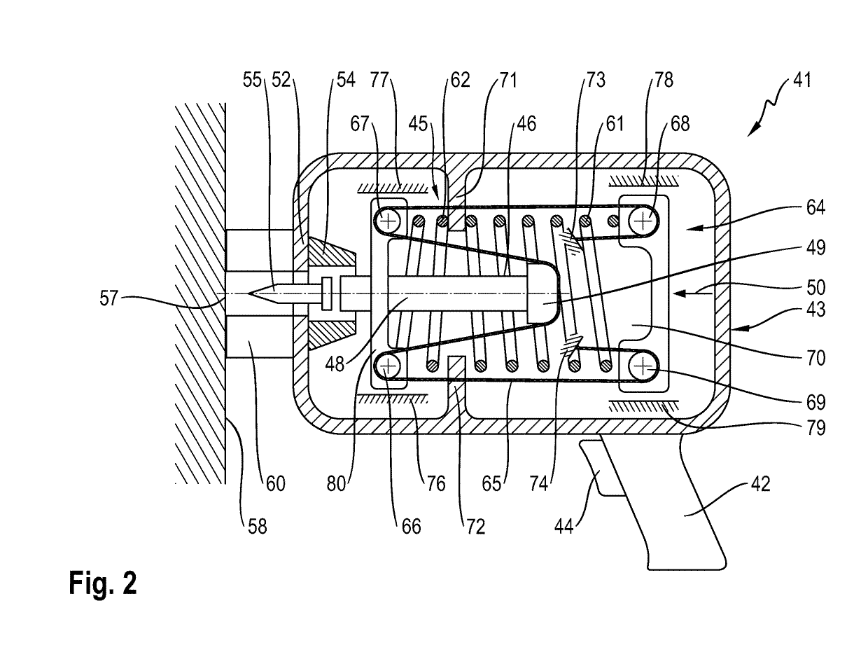

FIG. 2 shows a driving tool similar to that of FIG. 1 with two asymmetrical driving springs that are supported in a housing of the hand-held driving tool, in longitudinal section.

### EXEMPLARY EMBODIMENTS

Both FIGS. 1 and 2 show a simplified hand-held driving tool 1; 41 in the longitudinal section. The hand-held driving tool 1; 41 comprises a handle 2; 42, which is provided on a housing 3; 43. The handle 2; 42 is supplied with a switch trigger 4; 44, which is actuated by hand or with a finger to trigger a setting.

In the housing 3; 43 of the hand-held driving tool 1; 41, a drive arrangement generally designated as 5; 45 is arranged for a driving ram 6; 46. The driving ram 6; 46 is displaceably guided in a guide (not shown).

The driving ram 6; 46 comprises a driving section 8; 48 with which the driving ram 6; 46 is guided in the guide (not shown). In addition, the driving ram 6; 46 comprises a head section 9; 49. Over the head section 9; 49 during driving a corresponding driving force is applied to the ram 6; 46. An arrow 10; 50 shows the driving direction.

On one setting end 12; 52 of the hand-held driving tool 1; 41 a bolt guide 14; 54 is provided which is used to guide a fastening element 15; 55 and preferably comprises a buffer for the driving ram. During a setting process, the fastening element 15; 55 is driven into a substrate 18; 58 at a drive-in 17; 57.

The hand-held driving tool 1; 41 further comprises an attachment 20; 60 which is provided at the setting end 12; 52. The attachment 20; 60 is in proximity to the drive-in 17; 57 on the substrate 18; 58.

The hand-held driving tool 1; 41 further comprises a transmission device 24; 64. The transmission device 24; 64 is designed as a rope pull transmission with a transmission means 25; 65. The transmission means 25; 65 is guided over roller means 26 to 29; 66 to 69. The roller means 26, 27 of the transmission device 24 are rotatably attached to the housing 3.

The hand-held driving tool 1 shown in FIG. 1 comprises a driving spring element 21 that is designed as a helical compression spring. The transmission device 24 comprises a roller retainer 30 to which the roller means 28 and 29 are rotatably attached. By means of a symbol 31, a supporting point integral with the housing is indicated for an end of the driving spring element 21 facing the substrate 18.

By means of symbols 32 and 33, the housing-integral attachment points for the free ends of the transmission means 25, which is designed as a belt, are indicated. The symbols 34, 35 indicate a housing-integral guide for the roller retainer 30. The roller retainer 30, the driving ram 6, and the fastening element 15 are guided coaxially in the driving direction 10.

During setting of a fastening element 15; 55, the driving ram 6; 46 moves at high velocity in a forward direction, that is, in the direction of the substrate 18; 58. With the hand-held driving tool 1; 41, precisely at the time when the fastening element 15; 55 at the drive-in point 17; 57 penetrates the substrate 18; 58, a supporting force is exerted in the region of the fastening point on the surface of the substrate 18; 58 surrounding the drive-in point 17; 57. The force peak of the supporting force can amount to several kilonewtons. The effects time of the supporting force is advantageously a few milliseconds.

The hand-held driving tool 41 shown in FIG. 2 in contrast to the driving tool 1 shown in FIG. 1 comprises two driving spring elements 61, 62. The transmission device 24 of the hand-held driving tool 41 in contrast to the driving tool 1 shown in FIG. 1 comprises two roller retainers 70; 80.

The housing 43 of the hand-held driving tool 41 comprises the symbol-indicated housing-integral supporting points 71, 72. The facing ends of the driving spring elements 61, 62 at the housing-integral supporting points 71, 72 are supported on the housing 43. Symbols 73, 74 indicate that the free ends of the transmission means 65, which is designed as a belt, are connected to the housing 43 of the driving tool 41.

By means of symbols 76 and 77, a housing-integral guide to the roller retainer 80 is indicated. The symbols 78, 79 indicate a housing-integral guide for the roller retainer 70. The two roller means 68 and 69 are rotatably attached to the roller retainer 70. The two roller means 66, 67 are rotatably attached to the roller retainer 80.

The hand-held driving tool 1 shown in FIG. 1 functions as follows: the drive arrangement 5 and the transmission device 24 with the transmission means 25, the roller means 26 to 29 as well as the driving ram 6 are designed and mounted in such a way that upon expansion of the driving spring element 21, a force is exerted in the setting direction or driving direction 10 on the housing 3 and thus also on the substrate 18.

Upon setting of the fastening element 15, the driving spring element 21 pretensioned by the tensioning device (not shown) is released. At this point the driving spring element 21 is supported in the forward direction at 31 on the housing 3. The driving spring element 21 pushes backward on the roller retainer 30, which is displaceably guided in the housing 3.

The transmission means 25 is guided symmetrically over the rollers 28, 29 on the roller retainer 30 and over the housing-integral rollers 26, 27 as well as the head section 9 of the driving ram 6. The driving spring element 21 expands substantially backward. At this point the driving spring element 21 accelerates its own weight and the weight of the roller retainer 30 in a backward direction. At the same time the substantially lighter driving ram 6 is accelerated forward. As a result of the conservation of momentum, for a brief time there is a reaction force forward. The housing 3 of the driving tool 1 is hereby pressed via the attachment 20 onto the substrate 18.

Also with the driving tool 41 shown in FIG. 2, the driving ram 46 is accelerated during setting in a forward direction, thus in the direction of the substrate 58, in order to drive the fastening element 55 into the substrate 58. Here the driving ram 46 is accelerated by means of the transmission means 65 which is designed as a belt.

The energy for accelerating the driving ram 46 is provided by the two pretensioned driving spring elements 61 and 62, which are designed as helical compression springs. During acceleration of the driving ram 46, the driving spring element 61 expands from the housing-integral supporting points 71, 72 backward or in the backward direction, thus away from the substrate 58. The driving spring element 62 expands from the housing-integral supporting points 71, 72 forward or in a forward direction, thus toward the substrate 58.

The backward expanding driving spring element 61, as can be seen in FIG. 2, is larger and thereby heavier than the driving spring element 62 expanding forward. The result of this is, with respect to the housing-integral supporting points 71, 72, an asymmetry of the driving spring elements 61, 62. This asymmetry is advantageously so great that in the hand-held driving tool 41, during the driving of the fastening element 55 into the substrate 58, the above described supporting force is produced.

1. (canceled)

2. The hand-held driving tool according to claim 21, wherein the hand-held driving tool comprises an attachment which upon driving in of the fastening element, is arranged between the hand-held driving tool and the substrate, and over which the supporting force from the hand-held driving tool is transmitted to an area around the drive in point.

3. The hand-held driving tool according to claim 2, wherein the attachment is disengaged from the hand-held driving tool such that during a recoil movement of the hand-held driving tool counter to the driving direction, the attachment is not initially moved along with the hand-held driving tool.

4. The hand-held driving tool according to claim 21, wherein a sum of double the weight of the driving spring element and the weight of a roller retainer of the transmission device is greater than double the weight of the driving ram.

5. The hand-held driving tool according to claim 21, wherein the weight of the transmission device and/or of the driving spring element is adjusted to the weight of the driving ram such that a peak value of the supporting force is more than 100 N.

6. The hand-held driving tool according to claim 21, wherein the transmission device is a rope pull transmission with a transmission that is guided via at least one roller and is drivingly connected to the driving ram.

7. The hand-held driving tool according to claim 21, wherein the transmission device comprises at least one roller retainer having a weight, wherein the at least one roller weight is considered in adjustment of the weights of the transmission device and the driving ram.

8. The hand-held driving tool according to claim 21, wherein the hand-held driving tool comprises a housing, and driving springs supported on one side in the housing.

9. The hand-held driving tool according to claim 21, wherein the hand-held driving tool comprises a housing, and two asymmetrically designed driving springs that are supported in the housing.

10. A method of operating the hand-held driving tool according to claim 21, the method comprising driving a fastening element into a substrate, including moving, weighted parts of the transmission device and of the drive arrangement relative to one another such that the hand-held driving tool exerts a supporting force at a drive-in point on the substrate.

11. The method according to claim 10, wherein an effects time of the supporting force during driving in of the fastening element is smaller than a tenth of a second.

12. The method according to claim 11, wherein the effects time of the supporting force during driving in is smaller than a hundredth of a second.

13. The hand-held driving tool according to claim 5, wherein the peak value of the supporting force is more than 1000 N.

14. The hand-held driving tool according to claim 2, wherein a sum of double the weight of the driving spring element and the weight of a roller retainer of the transmission device is greater than double the weight of the driving ram.

15. The hand-held driving tool according to claim 3, wherein a sum of double the weight of the driving spring element and the weight of a roller retainer of the transmission device is greater than double the weight of the driving ram.

16. The hand-held driving tool according to claim 2, wherein the weight of the transmission device and/or of the driving spring element is adjusted to the weight of the driving ram such that a peak value of the supporting force is more than 100 N.

17. The hand-held driving tool according to claim 3, wherein the weight of the transmission device and/or of the driving spring element is adjusted to the weight of the driving ram such that a peak value of the supporting force is more than 100 N.

18. The hand-held driving tool according to claim 4, wherein the weight of the transmission device and/or of the driving spring element is adjusted to the weight of the driving ram such that a peak value of the supporting force is more than 100 N.

19. The hand-held driving tool according to claim 2, wherein the transmission device is a rope pull transmission with a transmission that is guided via at least one roller and is drivingly connected to the driving ram.

20. The hand-held driving tool according to claim 3, wherein the transmission device is a rope pull transmission with a transmission that is guided via at least one roller and is drivingly connected to the driving ram.

21. A hand-held driving tool for driving fastening elements into a substrate, the hand-held driving tool comprising a drive arrangement for a driving ram displaceably mounted in a guide, which is coupled via a transmission device to at least one driving spring element, wherein the driving ram is to be displaced in a driving direction toward a drive-in point of the substrate when the transmission device and the at least one driving spring element are moved counter to the driving direction, wherein the driving ram, the transmission device, and the driving spring element each have weights, wherein the weights of the transmission device and/or of the driving spring element are adjusted to the weight of the driving ram such that the hand-held driving tool, upon driving the fastening element at the drive-in point, experiences a supporting force acting in a direction of the substrate with the hand-held driving tool exerting pressure on surroundings of the drive-in point.
